(19) United States
(12) Patent Application Publication
(10) Pub. No.: US 2018/0071750 A1
(43) Pub. Date: Mar. 15, 2018

(54) PARTICLE CONCENTRATOR

(71) Applicant: SHIMADZU CORPORATION, Kyoto-shi (JP)

(72) Inventors: Hiroshi SEKI, Kyotanabe-shi (JP); Yoshihiro UENO, Uji-shi (JP); Hiroshi OKUDA, Kyoto-shi (JP); Hiromu SAKURAI, Tsukuba-shi (JP)

(73) Assignee: SHIMADZU CORPORATION, Kyoto-shi (JP)

(21) Appl. No.: 15/698,000

(22) Filed: Sep. 7, 2017

(30) Foreign Application Priority Data
Sep. 9, 2016 (JP) 2016-176798

(51) Int. Cl. B03C 3/47; B03C 3/41; B03C 3/017; G01N 1/22; G01N 15/02

(52) U.S. Cl. CPC B03C 3/47; B03C 3/41; G01N 2015/0038; G01N 1/2205; G01N 15/0266; B03C 3/0175

(57) ABSTRACT

A gas stream containing charged particles is introduced through a first gas inlet port into a first space, while another gas stream containing charged particles is introduced through a second gas inlet port into a second space located below and separated from the first space by a mesh-like filter. Voltages are respectively applied to an upper plate electrode, lower plate electrode 16 and filter to create a DC electric field within a housing. Due to this electric field, the charged particles contained in the gas stream flowing in the first space move toward the second space. The charged particles which have entered the second space through the openings of the filter are extracted through a gas outlet port along with the charged particles originally contained in the gas stream flowing in the second space.

### TECHNICAL FIELD

The present invention relates to a particle concentrator used for increasing the density of microparticles in a gas (the number of particles per unit volume).

### BACKGROUND ART

Micro-sized liquid or solid particles suspended in a gas are generally called aerosols. Most of the pollutants contained in the exhaust gas of automobiles or in the smoke emitted from manufacturing plants are also in the category of aerosols. In particular, aerosols with a particle size smaller than 1 μm, or so-called “nano-aerosols”, have raised concerns about their unfavorable influences on the health of individuals. Therefore, measuring their particle sizes or distribution of particle sizes has been extremely important in such areas as environmental measurement and assessment. As a device for measuring the particle-size distribution of aerosols, a differential mobility analyzer (DMA), which classifies microparticles using the difference in the moving speed of electrically charged microparticles within an electric field (electric mobility), has been popularly used.

If the density of the aerosols contained in a gas to be analyzed is low, it is necessary to concentrate the aerosols in order to improve the accuracy of the particle-size measurement or particle-size distribution measurement. For example, a virtual impactor (see Non Patent Literature 1 or other documents) and a concentrator disclosed in Patent Literature 1 have been known as conventional devices for concentrating aerosols. Any of these devices employs the effect of an aerodynamic force and the inertia of particles to separate aerosols in a gas into a plurality of groups with different ranges of particle sizes, or to extract aerosols included in a specific range of particle sizes from a stream of gas. With such concentrators, aerosols included in a specific range of particle sizes can be extracted in a concentrated form.

However, due to their concentration principle, it is difficult for those conventional concentrators to evenly concentrate aerosols over a wide range of particle sizes. Therefore, if the aerosols contained in a gas before concentration have a wide range of particle sizes, the particle-size distribution of the aerosols extracted through the condensation process becomes different from that of the aerosols in the gas before the concentration. Accordingly, the aforementioned concentrators are not suitable when the particle distribution of aerosols in a gas needs to be measured. Besides, it is difficult to concentrate small particles by those devices, since smaller particles have insufficient amounts of inertia and are more likely to be carried by a stream of gas supplied at a high flow rate. In practice, commonly used virtual impactors as described in Non Patent Literature 1 cannot concentrate particles whose sizes are smaller than the order of sub-microns; i.e., it is difficult to concentrate nano-aerosols.

### CITATION LIST

### Patent Literature

Patent Literature 1: JP 2015-96207 A

### Non Patent Literature

Non Patent Literature 1: “Haigasu-chuu No Ryuushijou Busshitsu No Shitsuryou Noudo Sokutei Houhou No JIS Wo Seitei (JIS Z 7152) (A Japanese Industrial Standard (JIS Z 7152) Legislated for Mass Concentration Measurement Methods for Particle Matters in Exhaust Gas)”, [online], [accessed on Nov. 6, 2015], Ministry of Economy, Trade and Industry, the Internet
Non Patent Literature 2: Seto and four other authors, “Characteristics of Surface-Discharge Microplasma Aerosol Charger (SMAC)”, J. Aerosol Res., 21 (3), 226-231 (2006)

### SUMMARY OF INVENTION

### Technical Problem

In recent years, there has been an increasing demand for a high-accuracy measurement of microparticles called “nanoparticles” whose size is on the order of nanometers. The conventional aforementioned concentrators cannot meet such a demand. The present invention has been developed to solve such a problem. Its objective is to provide a particle concentrator capable of almost evenly concentrating particles over a wide range of particle sizes, including such small particles that cannot be concentrated by conventional methods which use inertial forces.

### Solution to Problem

The present invention developed for solving the previously described problem is a particle concentrator for increasing the density of particles in a gas, including:

a) a housing in which a first gas stream and a second gas stream are formed inside, the second gas stream flowing adjacent to the first gas stream and in the same direction as the first gas stream, the first gas stream containing charged particles produced by electrically charging target particles to be concentrated, and the second gas stream containing either charged particles produced by electrically charging the target particles to be concentrated or non-charged particles which are the target particles with no electric charges;

b) an electric field creator for creating, within the housing, an electric field for making the charged particles in the first gas stream move across the first gas stream to the second gas stream; and

c) an outlet section for extracting, from the housing, the second gas stream containing the charged particles transferred by the electric field created by the electric field creator.

In the particle concentrator according to the present invention, when the electric field is created within the housing by the electric field creator, the charged particles in the first gas stream move toward the second gas stream due to the effect of the electric field. Meanwhile, the carrier gas (e.g. air), which is the main constituent of the gas stream, is not affected by the electric field. Therefore, only the charged particles in the first gas stream are transferred to the second gas stream. Those charged particles are eventually extracted through the outlet section to the outside along with the charged and non-charged particles which have been originally contained in the second gas stream. As a result, a gas stream which has an increased particle density, i.e. which contains the particles in a concentrated form, is extracted from the outlet section.

In the particle concentrator according to the present invention, the electric field creator may include: one pair or a plurality of pairs of electrodes arranged within the housing in such a manner as to face each other across the first gas stream and the second gas stream; and a DC power source for applying predetermined one or a plurality of DC voltages to the electrodes. Each pair of electrodes may be plate electrodes which are arranged substantially parallel to each other or cylindrical electrodes which are concentrically arranged.

In the particle concentrator according to the present invention, the flow rate of the first gas stream may preferably be greater than the flow rate of the second gas stream. This improves the particle concentration efficiency.

The particle concentrator according to the present invention may further include: a filter which is an electrode having an opening that allows particles to pass through, the filter forming a virtual plane dividing an inner space of the housing into a first space in which the first gas stream flows and a second space in which the second gas stream flows; and an auxiliary power source for applying a predetermined voltage to the filter.

For example, the filter may have a configuration including a plurality of rod electrodes or wire electrodes arranged in a grid-like form, or a plurality of rod electrodes arranged parallel to each other.

In the previously described configuration of the particle concentrator, an appropriate DC voltage can be applied from the auxiliary power source to the filter to effectively separate the electric field within the first space and the electric field within the second space, with the strength of each electric field appropriately regulated. With this system, the electric field can be strengthened within the first space to make a considerable amount of force act on the charged particles in the first gas stream and efficiently transfer those particles into the second gas stream, while the electric field within the second space can be weakened to maximally prevent the charged particles in the second gas stream from coming in contact with the electrodes forming the electric field creator.

In the previously described configuration of the particle concentrator, it is preferable that the device further includes a gas inlet section for introducing a gas stream containing particles into the first space and a charging section for electrically charging the particles in the gas stream introduced from the gas inlet section, where the gas stream containing charged particles produced in the charging section flows in the first space as the first gas stream.

In this configuration, in place of the charged particles, non-charged particles are introduced through the gas inlet section into the first space in the housing, and those particles are electrically charged by the charging section. The generated charged particles undergo the effect of the electric field created by the electric field creator, so that they promptly leave the first gas stream and enter the second space through the filter. Accordingly, even when non-charged particles are directly introduced into the housing, those particles can be concentrated.

Specifically, the charging section may be configured to electrically charge target particles by making them come in contact with gas ions. It may include a gas ion generator for generating gas ions for electrically charging particles within the first space, or a gas ion supplier for supplying the first space with gas ions generated outside the housing. The method for generating gas ions is not specifically limited. For example, it is preferable to use the surface discharge (e.g. dielectric barrier discharge), corona discharge, arc discharge, spark discharge, atmospheric pressure glow discharge or the like.

In the previously described configuration of the particle concentrator, the filter may preferably include a pair of electrodes separated from each other by a predetermined distance, and the auxiliary power source may be configured to prevent gas ions within the first space from passing through the filter by applying a predetermined AC voltage between the pair of electrodes.

The AC voltage may be a sinusoidal voltage or a non-sinusoidal voltage (e.g. rectangular voltage).

In the previously described configuration of the particle concentrator, when AC voltages having the same frequency with an appropriate phase difference are respectively applied from the auxiliary power source to the pair of electrodes forming the filter, the gas ions which have smaller masses and higher mobilities than the charged particles will be captured by the electrodes while the charged particles are allowed to pass through the gap between the neighboring electrodes. Therefore, when the gas ions used for electrically charging particles are present within the first space, those gas ions are prevented from flowing into the second space due to the effect of the electric field created by the electric field creator. Consequently, the situation in which the charged particles come in contact with the gas ions within the second space is avoided. This suppresses the multiple charging of the particles as well as prevents the gas ions from being contained in the gas stream extracted from the outlet section.

### Advantageous Effects of the Invention

The particle concentrator according to the present invention can evenly concentrate particles contained in an ambient air or specific kind of gas, regardless of their sizes (i.e. particle sizes), including such small particles that cannot be concentrated by conventional methods which use inertial forces. Since the change in the particle-size distribution before and after the concentration is small, the device is suitable for applications in which the particle-size distribution of a sample having a low level of overall particle concentration is measured after the particle concentration of the sample is increased. Furthermore, the device can efficiently concentrate microparticles whose particle sizes are on the order of nanometers, and is therefore suitable for accurate measurements of such microparticles.

### BRIEF DESCRIPTION OF DRAWINGS

FIG. 1 is a vertical sectional end view showing a schematic configuration of a particle concentrator according to the first embodiment of the present invention.

FIG. 2 is a vertical sectional end view showing a schematic configuration of a variation of the particle concentrator in the first embodiment.

FIG. 3A is a vertical sectional end view showing a schematic configuration of a particle concentrator according to the second embodiment of the present invention, and FIG. 3B is a sectional end view at the arrowed line A-A′ in FIG. 3A.

FIG. 4 is a perspective view of the filter in the particle concentrator in the second embodiment.

FIG. 5 is a plan view of another example of the filter in the particle concentrator in the second embodiment.

FIG. 6 is a schematic configuration of a variation of the particle concentrator according to the second embodiment.

FIG. 7 is a vertical sectional end view showing a variation of the particle concentrator in the first embodiment.

### DESCRIPTION OF EMBODIMENTS

### First Embodiment

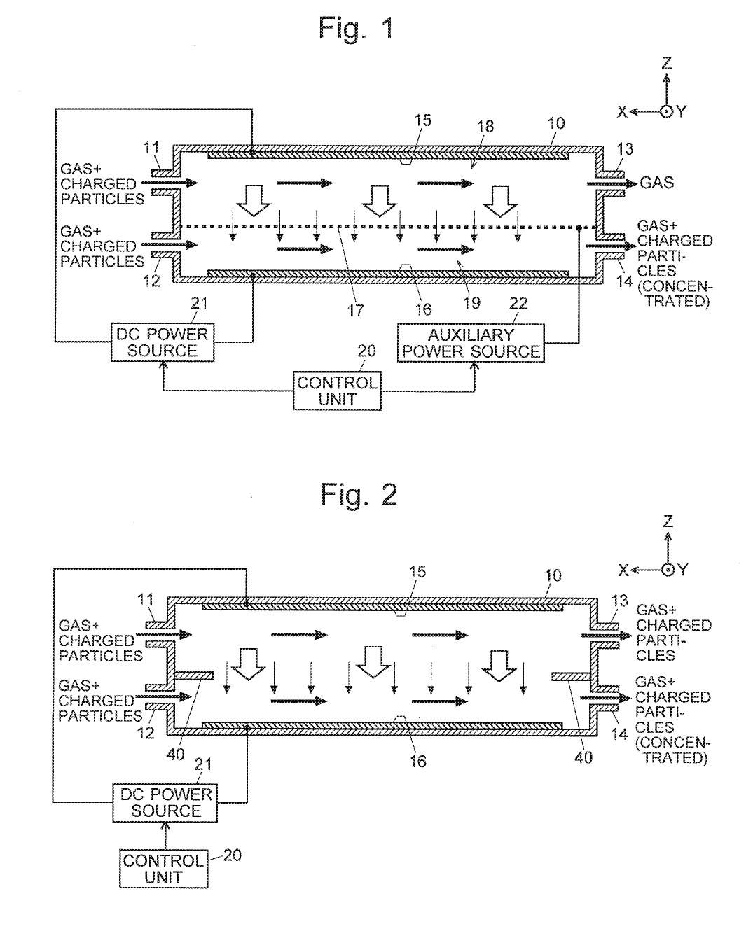

A particle concentrator as the first embodiment of the present invention is hereinafter described with reference to FIG. 1. FIG. 1 is a vertical sectional view showing a schematic configuration of the particle concentrator in the present embodiment.

For convenience of explanation, the front-rear, up-down and left-right directions are defined in such a manner that the X, Y and Z directions indicated in FIG. 1 correspond to the leftward, frontward and upward directions, respectively. The same applies in FIGS. 2, 3A, 3B and 6 (which will be described later).

The particle concentrator in the first embodiment includes a substantially rectangular parallelepiped housing 10. In the left sidewall of the housing 10, a first gas inlet port (which corresponds to the gas inlet section in the present invention) 11 and a second gas inlet port 12 are vertically arranged, both of which are an opening for admitting a flow of gas from the outside into the housing 10. In the right sidewall of the housing 10, a first gas outlet 13 and a second gas outlet (which corresponds to the outlet section in the present invention) 14 are vertically arranged, both of which are an opening for discharging gas from the housing 10 to the outside. The first gas inlet port 11 and the first gas outlet port 13 are substantially aligned with each other. Similarly, the second gas inlet port 12 and the second gas outlet port 14 are substantially aligned with each other.

Inside the housing 10, a first plate electrode 15 is provided on the upper surface, while a second plate electrode 16 is provided on the lower surface. Between the first and second plate electrodes 15 and 16, a filter 17 which is a flat mesh-like electrode is provided substantially parallel to those plate electrodes. The space between the first plate electrode 15 and the filter 17 is hereinafter called the “first space” 18, while the space between the filter 17 and the second plate electrode 16 is called the “second space” 19. A main DC power source 21 applies DC voltages U1 and U2 to the first and second plate electrodes 15 and 16, respectively. An auxiliary power source 22 applies a predetermined DC voltage U3 to the electrodes forming the filter 17. Both power sources are controlled by a control unit 20.

An operation of the particle concentrator in the first embodiment is hereinafter described.

A carrier gas (e.g. air) containing the particles to be concentrated is introduced through the first gas inlet port 11 into the housing 10. The carrier gas (e.g. air) containing the particles to be concentrated is also introduced through the second gas inlet port 12 into the housing 10. The carrier gas introduced from the second gas inlet port 12 is supplied at a lower flow rate than the carrier gas introduced from the first gas inlet port 11. The particles contained in the two streams of carrier gas are previously charged particles.

Although the filter 17 which is shaped like a grid has a large number of openings, the space inside the housing 10 is roughly divided into the first and second spaces 18 and 19 by this filter 17. Therefore, the carrier gas introduced through the first gas inlet port 11 flows through the first space 18 from left to right and exits from the first gas outlet port 13 to the outside, while the carrier gas introduced through the second gas inlet port 12 flows through the second space 19 from left to right and exits from the second gas outlet port 14 to the outside (see the thick black arrows in FIG. 1). In other words, the two gas streams respectively formed in the first and second spaces 18 and 19 flow in substantially the same direction as well as substantially parallel to each other.

As noted earlier, the filter 17 has the function of roughly dividing the inner space of the housing 10. Due to the DC voltage U3 applied to the filter 17, the filter 17 also has the function of separating the electric field within the first space 18 from the electric field within the second space 19. For example, if U1>U3>U2, a potential difference of U1−U3 is present between the first plate electrode 15 and the filter 17, i.e. across the first space 18, and a DC electric field due to this potential difference is created. Meanwhile, a potential difference of U3−U2 is present between the filter 17 and the second plate electrode 16, i.e. across the second space 19, and a DC electric field due to this potential difference is created. The DC voltage U3 is appropriately set so that the potential difference across the first space 18 becomes greater than the potential difference across the second space 19. Accordingly, the DC electric field within the first space 18 becomes stronger than the DC electric field within the second space 19.

These DC electric fields are DC electric fields having a downward potential gradient for the charged particles in the direction indicated by the thick white arrows in FIG. 1. Due to this electric field, the charged particles in the carrier gas flowing in the first space 18 undergo a downward force and pass through the openings of the filter 17 (which is a mesh-like electrode) into the second space 19, as indicated by the thin downward arrows in FIG. 1. As noted earlier, the DC electric field within the first space 18 is strong. Therefore, the charged particles in the carrier gas flowing in the first space 18 undergo a significant amount of force, whereby the charged particles are efficiently introduced into the second space 19. Electrically neutral gas molecules are unaffected by the electric field.

Since the DC electric field within the second space 19 is relatively weak, the charged particles which have entered the second space 19 undergo a smaller amount of force. Therefore, the charged particles which have reached the second space 19 do not directly collide with the second plate electrode 16; the charged particles are carried by the carrier gas flowing from the second gas inlet port 12 toward the second gas outlet port 14. This carrier gas originally contains charged particles. The spatial density of these particles is increased by the addition of the charged particles transferred from the first space 18 by the effect of the electric field in the previously described manner. Consequently, a carrier gas which contains the charged particles in a concentrated form is extracted from the second gas outlet port 14 to the outside. Meanwhile, a carrier gas which has been deprived of the charged particles and contains almost no charged particles (or only a small quantity of them) is extracted from the first gas outlet port 13 to the outside.

Thus, in the particle concentrator according to the present embodiment, a carrier gas containing charged particles in a concentrated form can be extracted through the second gas outlet port 14.

The values of the DC voltages U1, U2 and U3 respectively applied to the plate electrodes 15, 16 and filter 17, the gas flow rate in the second space 19 as well as other relevant parameters can be determined beforehand, for example, by experiments so that the charged particles will be satisfactorily transferred from the first space 18 into the second space 19 while the charged particles that have entered the second space 19 will be assuredly carried by the carrier gas stream.

As for the filter 17, a plurality of rod electrodes arranged parallel to each other, as will be described later in the second embodiment, may be used in place of the mesh-like electrode.

In the particle concentrator according to the first embodiment, the filter 17 which divides the inner space of the housing 10 into upper and lower sections is provided. This filter 17 is dispensable. A configuration with no filter 17 is also possible, as shown in FIG. 2. However, removing the filter 17 allows the carrier gas stream flowing from the first gas inlet port 11 toward the first gas outlet port 13 to be easily mixed with the carrier gas stream flowing from the second gas inlet port 12 toward the second gas outlet port 14. Therefore, as shown in FIG. 2, an appropriate current plate 40 may preferably be provided to make each gas stream flow as straight as possible. Additionally, since the DC electric field created between the plate electrodes 15 and 16 has a uniform potential gradient in the Z direction, attention needs to be paid to the adjustment of the potential differences and the gas flow rates so that the charged particles moving downward will not easily collide with the second plate electrode 16.

In the particle concentrator according to the first embodiment, the housing 10 has a substantially rectangular parallelepiped shape, with its inner space divided into the first space 18 and the second space 19 by the filter 17. The shape of the housing 10 as well as other features may be appropriately changed.

FIG. 7 is a schematic vertical sectional view of a particle concentrator using a cylindrical housing 10 with both end faces closed. The circumferential wall of the housing 10 as well as the first plate electrode 15, cylindrical filter 17 and second plate electrode 16 inside the wall are concentrically arranged, forming a double-cylinder structure in which the outer and inner cylinders are formed by the first space 18 between the first plate electrode 15 and the filter 17 as well as the second space 19 between the filter 17 and the second electrode 16. The carrier gas containing charged particles is supplied in the direction orthogonal to the plane of paper of FIG. 7. Due to the effect of the electric field created by the DC voltages respectively applied to the first and second plate electrodes 15 and 16, the charged particles in the outer first space 18 are transferred through the openings of the filter 17 into the inner second space 19. Consequently, as in the first embodiment, a carrier gas containing the charged particles in a concentrated form can be extracted from the gas outlet port (not shown) communicating with the second space 19.

### Second Embodiment

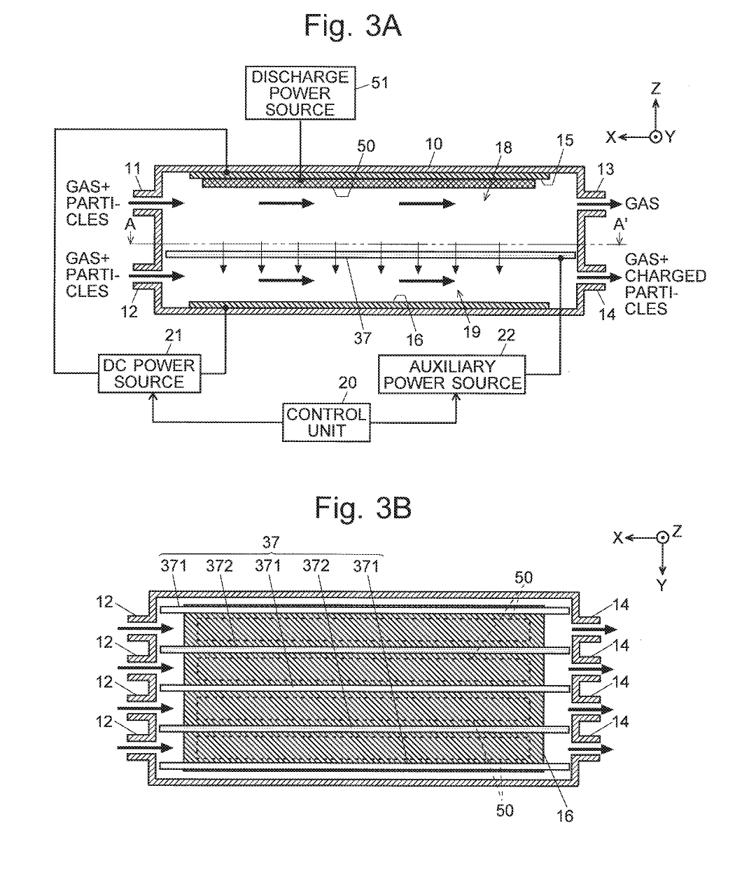

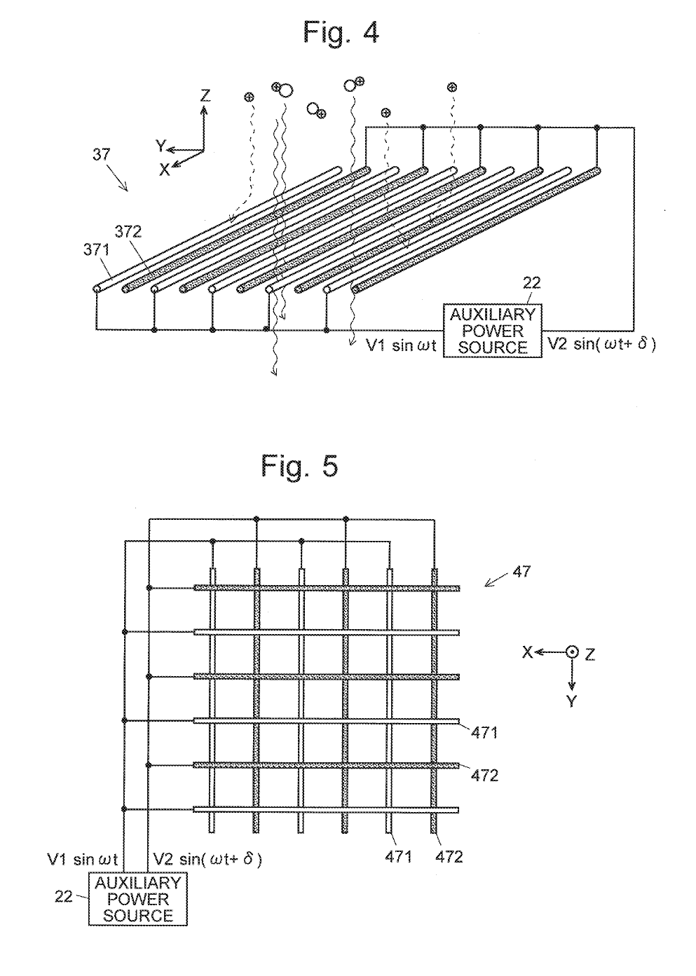

A particle concentrator as the second embodiment of the present invention is hereinafter described with reference to FIGS. 3A, 3B and 4. FIG. 3A is a vertical sectional view showing a schematic configuration of the particle concentrator in the second embodiment. FIG. 3B is a sectional view at the arrowed line A-A′ in FIG. 3A. FIG. 4 is a perspective view of the filter 37 in the particle concentrator according to the second embodiment. In FIGS. 3A, 3B and 4, the components which are identical or correspond to those used in the device according to the first embodiment are denoted by the same numerals.

In the particle concentrator according to the first embodiment, a carrier gas containing charged particles generated outside the housing 10 is supplied into the housing 10. By comparison, in the particle concentrator according to the second embodiment, a carrier gas containing particles that are not electrically charged is supplied at least through the first gas inlet port 11 into the housing 10. Those particles are electrically charged within the first space 18. Due to the effect of the electric field, the electrically charged particles are transferred to the second space 19, as in the first embodiment. For the electric charging of the particles within the first space 18, a plurality of discharge devices 50 are arranged under the first plate electrode 15. A high voltage for electric discharge is applied from a discharge power source 51 to each discharge device 50. The discharge device 50 used in this embodiment is a surface-discharge microplasma device disclosed in Non Patent Literature 2 or other documents. It is possible to use an ion generation device employing one of various kinds of other electric discharge, such as a corona discharge, arc discharge, spark discharge, dielectric barrier discharge or atmospheric pressure glow discharge. Needless to say, an ion generation device using a radioactive isotope or the like may also be used in place of the discharge device 50.

As shown in FIG. 4, the filter 37 includes a plurality of rod electrodes 371 and 372 arranged parallel to each other at predetermined intervals of space on a plane. Those rod electrodes include a pair of electrode groups each of which consists of a plurality of rod electrodes (371 or 372) located at every other line in the Y direction. Two AC voltages V1 sin ωt and V2 sin(ωt+δ) having the same frequency and different phases are respectively applied from the auxiliary power source 22 to one group of rod electrodes 371 and the other group of rod electrodes 372. The phase difference 6 may be appropriately determined; normally, the value is within a range from 90 to 270 degrees. The amplitudes V1 and V2 of those AC voltages are also appropriately determined. Though not shown in FIG. 4, it is preferable to apply not only the AC voltages but also an appropriate DC voltage to the filter 37, as in the first embodiment.

In the particle concentrator according to the second embodiment, when the predetermined voltages are applied from the discharge power source 51 to the discharge devices 50, and electric discharge is induced at the discharge devices 50, the gas molecules in the carrier gas are ionized, turning into gas ions. When the particles (non-charged particles) in the carrier gas come in contact with those gas ions, a transfer of electrons occurs between the particles and the gas ions, whereby the particles become electrically charged. As in the device according to the first embodiment, the generated charged particles undergo forces due to the DC electric field created within the first space 18, and move downward.

As noted earlier, two AC voltages with different phases are respectively applied to the rod electrodes 371 and 372 neighboring each other in the filter 37 which separates the first and second spaces 18 and 19. Therefore, when the charged particles moving downward within the housing 10 in the previously described manner are about to pass through the gap between the rod electrodes 371 and 372, the particles undergo attraction and repulsion from the rod electrodes 371 and 372 on both sides. An object with a comparatively high mobility is quickly attracted to and collides with one of the rod electrodes 371 and 372, failing to pass through the gap (opening) between those electrodes. By comparison, when an object with a comparatively low mobility is attracted toward one of the rod electrodes 371 and 372, the object will be attracted in the opposite direction by the other electrode before colliding with the former electrode. Accordingly, this object can pass through the space between the rod electrodes 371 and 372, oscillating in the Y direction in a stable manner.

By comparison, the gas ions generated by the electric discharge are much smaller in mass than the charged particles and have higher mobilities. Therefore, by appropriately controlling the conditions (amplitude, frequency and phase difference) of the voltages applied from the auxiliary power source 22 to the rod electrodes 371 and 372, it is possible to create a situation in which only the charged particles are allowed to pass through the filter 37 while the gas ions are captured by (or collide with) the filter 37. As a result, only the charged particles having lower mobilities than the gas ions are transferred from the first space 18 into the second space 19. If a large amount of gas ions is allowed to flow into the second space 19, the charged particles are likely to once more come in contact with those gas ions, causing multiple charging. The configuration in the second embodiment suppresses the inflow of the gas ions into the second space 19 and thereby prevents the charged particles from additionally coming in contact with the gas ions. Thus, the multiple charging is suppressed. This increases the proportion of singly-charged particles to all charged particles extracted from the second gas outlet port 14.

The conditions of the voltages applied to the filter 37 for allowing only the charged particles to pass through are previously investigated, for example, by experiments for each particle (kind, size and/or other properties) and stored in a memory inside the control unit 20. When the particle to be observed is specified by a user, the control unit 20 refers to the information stored in the memory and determines the conditions of the voltages corresponding to the particle to be observed, as well as controls the auxiliary power source 22 so that the determined voltages will be applied to the rod electrodes 371 and 372 forming the filter 37.

The filter 37 does not always need to be a plurality of rod electrodes 371 and 372 arranged in the previously described manner. As shown in FIG. 4, it may be a structure including a plurality of thin wire electrodes 471 and 472 arranged in a grid-like form, i.e. a mesh-like structure in a plan view. In this filter 47, an electrode group consisting of the electrodes 471 and 472 arranged in the vertical direction (Y direction), and another electrode group consisting of the electrodes 471 and 472 arranged in the horizontal direction (X direction), are separated from each other in the acting direction of the force due to the electric field created by the first and second plate electrodes 15 and 16 (Z direction). AC voltages V1 sin ωt and V2 sin(ωt+δ) having the same frequency and different phases are respectively applied to the electrodes 471 and 472 neighboring each other. Accordingly, the basic operation of this filter is the same as that of the previously described filter 37; it allows only the charged particles with low mobilities to pass through while preventing the passage of the gas ions with high mobilities.

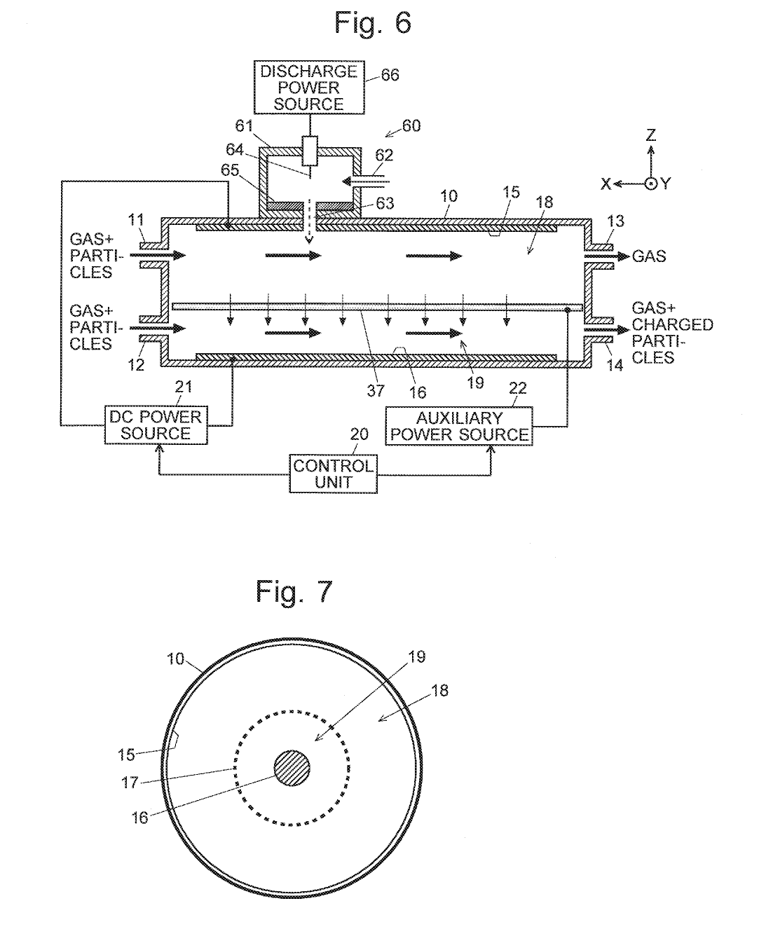

In the device according to the second embodiment, the gas ions are generated within the first space 18. Alternatively, the gas ions may be generated outside the housing 10 and supplied into the first space 18. In the variation shown in FIG. 6, a gas ion generator 60 is provided on top of the housing 10, and gas ions generated by this gas ion generator 60 are introduced into the housing 10. The gas ion generator 60 has a substantially rectangular parallelepiped chamber 61. A gas inlet port 62 for introducing a gas for generating gas ions into the chamber 61 is provided in the sidewall of the chamber 61. An opening 63 for allowing the gas ions generated within the chamber 61 to flow into the first space 18 is formed in the bottom wall of the chamber 61. Within the inner space of the chamber 61, a needle-shaped discharge electrode 64 vertically extending from the upper surface is installed. A plate-shaped ground electrode 65 forming a pair with the discharge electrode 64 is installed at the inner bottom of the chamber 61. When a predetermined voltage is applied from a discharge power source 66 provided outside the chamber 61 to the discharge electrode 64, a corona discharge is induced, and the gas introduced through the gas inlet port 62 is ionized. The generated gas ions are supplied through the opening 63 into the first space 18. Within the first space 18, those gas ions come in contact with particles and electrically charge those particles.

Needless to say, the device shown in FIG. 7 may also be configured to electrically charge particles within the first space 18 by generating gas ions within the first space 18 or introducing gas ions from outside into the same space 18.

It should be noted that the previous embodiments are mere examples of the present invention, and any modification, change or addition appropriately made within the spirit of the present invention will evidently fall within the scope of claims of the present application.

### REFERENCE SIGNS LIST

10 . . . Housing
11 . . . First Gas Inlet Port
12 . . . Second Gas Inlet Port
13 . . . First Gas Outlet Port
14 . . . Second Gas Outlet Port
15 . . . First Plate Electrode
16 . . . Second Plate Electrode
17, 37, 47 . . . Filter
171, 171, 371, 372, 471, 472 . . . Electrode
18 . . . First Space
19 . . . Second Space
20 . . . Control Unit
21 . . . DC Power Source
22 . . . Auxiliary Power Source
40 . . . Current Plate
50 . . . Discharge Device
51, 66 . . . Discharge Power Source
60 . . . Gas Ion Generator
61 . . . Chamber
62 . . . Gas Inlet Port
63 . . . Opening
64 . . . Discharge Electrode
65 . . . Ground Electrode

1. A panicle concentrator for increasing a density of particles in a gas, comprising:
a) a housing in which a first gas stream and a second gas stream formed inside, the second gas stream flowing adjacent to the first gas stream and in the same direction as the first gas stream, the first gas stream containing charged particles produced by electrically charging target particles to be concentrated, and the second gas stream containing either charged particles produced by electrically charging the target particles to be concentrated or non-charged particles which are the target particles with no electric charges;
b) an electric field creator for creating, within the housing, an electric field for making the charged particles in the first gas stream move across the first gas stream to the second gas stream; and
c) an outlet section for extracting, from the housing, the second gas stream containing the charged particles transferred by the electric field created by the electric field creator.

2. The particle concentrator according to claim 1, wherein:
a flow rate of the first gas stream is greater than a flow rate of the second gas stream.

3. The particle concentrator according to claim 2, further comprising:
a filter which is an electrode having an opening that allows particles to pass through, the filter forming a virtual plane dividing an inner space of the housing into a first space in which the first gas stream flows and a second space in which the second gas stream flows; and
an auxiliary power source for applying a predetermined voltage to the filter.

4. The particle concentrator according to claim 3, further comprising:
a gas inlet section for introducing a gas stream containing particles into the first space and;
a charging section for electrically charging the particles in the gas stream introduced from the gas inlet section,
wherein the gas stream containing charged particles produced in the charging section flows in the first space as the first gas stream.

5. The particle concentrator according to claim 4, wherein:
the charging section comprises either a gas ion generator for generating gas ions for electrically charging particles within the first space, or a gas ion supplier for supplying the first space with gas ions generated outside the housing.

6. The particle concentrator according to claim 4, wherein:
the filter comprises a pair of electrodes separated from each other by a predetermined distance; and
the auxiliary power source prevents gas ions within the first space from passing through the filter by applying a predetermined AC voltage between the pair of electrodes.

7. The particle concentrator according to claim 5, wherein
the filter comprises a pair of electrodes separated from each other by a predetermined distance; and
the auxiliary power source prevents gas ions within the first space from passing through the filter by applying a predetermined AC voltage between the pair of electrodes.
